(19) United States
(12) Patent Application Publication
(10) Pub. No.: US 2012/0056505 A1
(43) Pub. Date: Mar. 8, 2012

(54) ELECTROSTATIC GENERATING APPARATUS FOR GENERATING AN ELECTROSTATIC CHARGE

(76) Inventor: Victor Mayorkis, Foster City, CA (US)

(21) Appl. No.: 12/876,423

(22) Filed: Sep. 7, 2010

(51) Int. Cl. H02N 1/12

(52) U.S. Cl. 310/309

(57) ABSTRACT

There is provided an electrostatic generating apparatus comprising a body, which houses an electrostatic charge separating member for generating an electrostatic charge; a motive member and a source of power for providing motive to the electrostatic charge separating member; a charge-collector for collecting the electrostatic charge; the electrostatic charge separating member including a first roller, a second roller and a belt therebetween; the motive member including a driving gear mounted onto the motive member, the driving gear configured to operatively engage at least one of the first roller and the second roller for imparting the movement onto the belt.

### FIELD OF THE INVENTION

The present invention generally relates to, but is not limited to, an electrostatic generating apparatus and more specifically the present invention relates to, but is not limited to, to an electrostatic generating apparatus for generating an electrostatic charge.

### BACKGROUND OF THE INVENTION

An electrostatic generating apparatus has been generally known in the art and has many applications, also known to those of skill in the art as a “Van de Graaf generator”. Generally speaking, the Van de Graaf generator creates high voltages using a system that separates positive and negative charges, collects one of the so-separated charges on a charge collector, typically implemented as an electrode system, and conveys the other charge to the ground.

The charge polarity on the charge collector is considered to be the charge generated by the Van de Graaf generator.

Implementations of the Van de Graaf generator usually include a system of two rollers and a conveyor belt running over them; two electrode systems where one is connected to a charge collector, and another is coupled with a wire that leads to a ground either via the regular power outlet or via designated ground terminal. Within known implementations, the electrode system can be generally categorized as a brush connected to either the charge collector (which can be implemented as a hollow vessel) or to another electrode connected to a ground. Each one of the brushes is located in vicinity of the belt and is used for collection of separated charges. More specifically, implementations of the Van de Graaf generator usually include a system of two rollers and a conveyor belt running over them; a terminal that provides ground and a source of power; and a hollow sphere-vessel that is mounted on top of the column and keeps the upper roller inside the sphere. The sphere serves as a charge collector for the generator. The high voltage charge created by the Van de Graaf generator and the polarity of the charge are determined by the charge present on the charge collector.

One of the applications includes using the electrostatic generating apparatus for educational purposes, such as for conducting and demonstrating various science-related experiments. Natural application of this finds itself in schools and other educational establishments. Other applications include use in the toy industry and the like.

Within known prior art implementations, such generators can typically generate a charge of a single polarity—the so-generated charge being either positive or negative. Sometimes, the experiments that involve the Van de Graaf generator require presence of either positive or negative charge, which in turn requires purchase and use of two different generators—one of which is capable of generating a positive charge and another one which is capable of generating a negative charge.

The general implementation of the charge separation and mechanics of the Van de Graaf generator are generally known to those of skill in the art. The general implementation of the Van de Graaf generator includes mounting one of the rollers on the axel of the power source (usually an AC or a DC motor), and thus the power source is located on the side of the roller. This known implementation constrains the power source and the roller in a particular spatial configuration, which does not allow their separation and also negatively impacts the real estate required to implement such an arrangement.

U.S. Pat. No. 1,991,236 issued on Feb. 12, 1935 to R. J. Van De Graaf discloses an electrostatic generator for the production of direct current voltages and an apparatus that includes the electrostatic generator an electrical device, such as an X-ray tube, operated thereby.

U.S. Pat. No. 2,885,599 issued on May 5, 1959 to E. E. Hand at al describes charge transferring means for electrostatic generators.

U.S. Pat. No. 2,922,905 issued on Jan. 26, 1960 to R. J. Van De Graaf teaches an apparatus for reducing electron loading in positive-ion accelerators.

US patent application 20090209171 published on Aug. 20, 2009 to Kriman et al teaches an electrostatic toy has a levitating object; and an electrostatic wand which causes levitation of the object and is provided with an electrostatic generator that charges the wand and is operatable by one hand of a user.

### SUMMARY OF THE INVENTION

According to a first broad aspect of the present invention, there is provided an electrostatic generating apparatus, which comprises a body housing: an electrostatic charge separating member for separating an electrostatic charge; a motive member and a source of power for providing motive to the electrostatic charge separating member; a charge-collector for collecting the electrostatic charge; the electrostatic charge separating member including a first roller, a second roller and a belt therebetween; the motive member including a driving gear mounted onto the motive member, the driving gear configured to operatively engage at least one of the first roller and the second roller for imparting the movement onto the belt.

According to a second broad aspect of the present invention, there is provided an electrostatic generating apparatus which comprises a body including a first body portion, a second body portion and a third body portion; the second body portion being configured to selectively alternatively operatively couple to one of the first body portion and the third body portion, into a first operational configuration and a second operational configuration, respectively; the electrostatic generating apparatus being configured to generate a charge of a positive polarity in said first operational configuration and a charge of a negative polarity in said second operational configuration.

According to yet another broad aspect of the present invention, there is provided in an electrostatic generating apparatus having an electrostatic charge separating member and a motive member, the improvement that comprises the motive member is used as a part of an electrode system used for grounding replacing brush or comb of electrostatic Van de Graaf generator.

These and other aspects and features of non-limiting embodiments of the present invention will now become apparent to those skilled in the art upon review of the following description of specific non-limiting embodiments of the invention in conjunction with the accompanying drawings.

### DESCRIPTION OF THE DRAWINGS

A better understanding of the embodiments of the present invention (including alternatives and/or variations thereof) may be obtained with reference to the detailed description of the embodiments along with the following drawings, in which:

FIG. 1 depicts a front sectional view of an electrostatic generating apparatus in an assembled state, the electrostatic generating apparatus being implemented in accordance with a non-limiting embodiment of the present invention.

FIG. 2 depicts a front sectional view of the electrostatic generating apparatus of FIG. 1, the electrostatic generator being in an un-assembled state.

FIG. 3 depicts a front sectional view of the electrostatic generating apparatus in an assembled state, the electrostatic generating apparatus being implemented in accordance with another non-limiting embodiment of the present invention.

FIG. 4 depicts a front sectional view of a portion of the electrostatic generating apparatus of FIG. 1.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION OF EMBODIMENTS

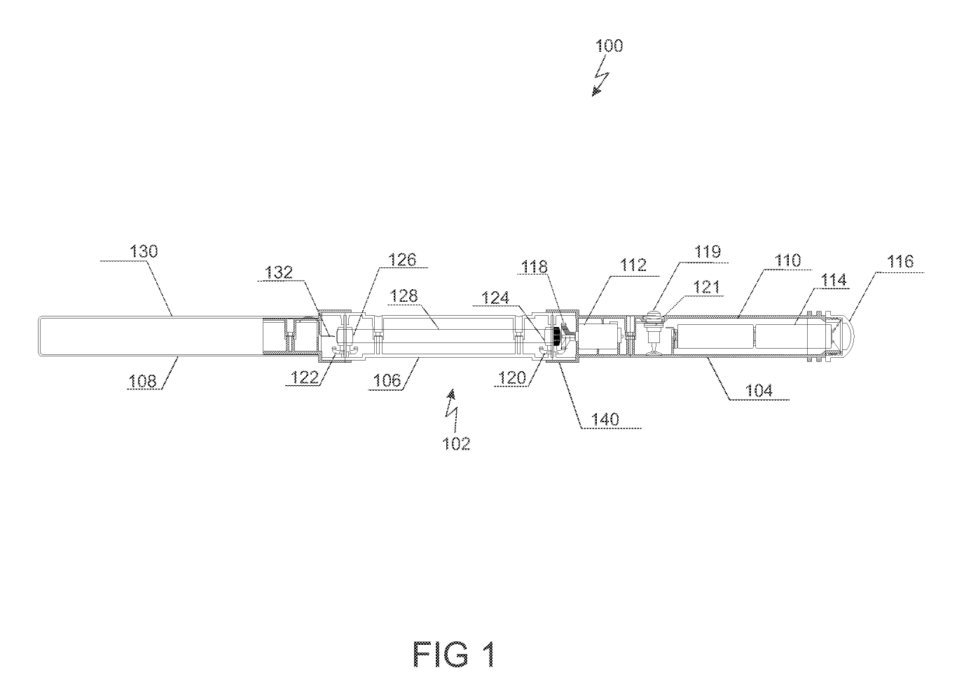

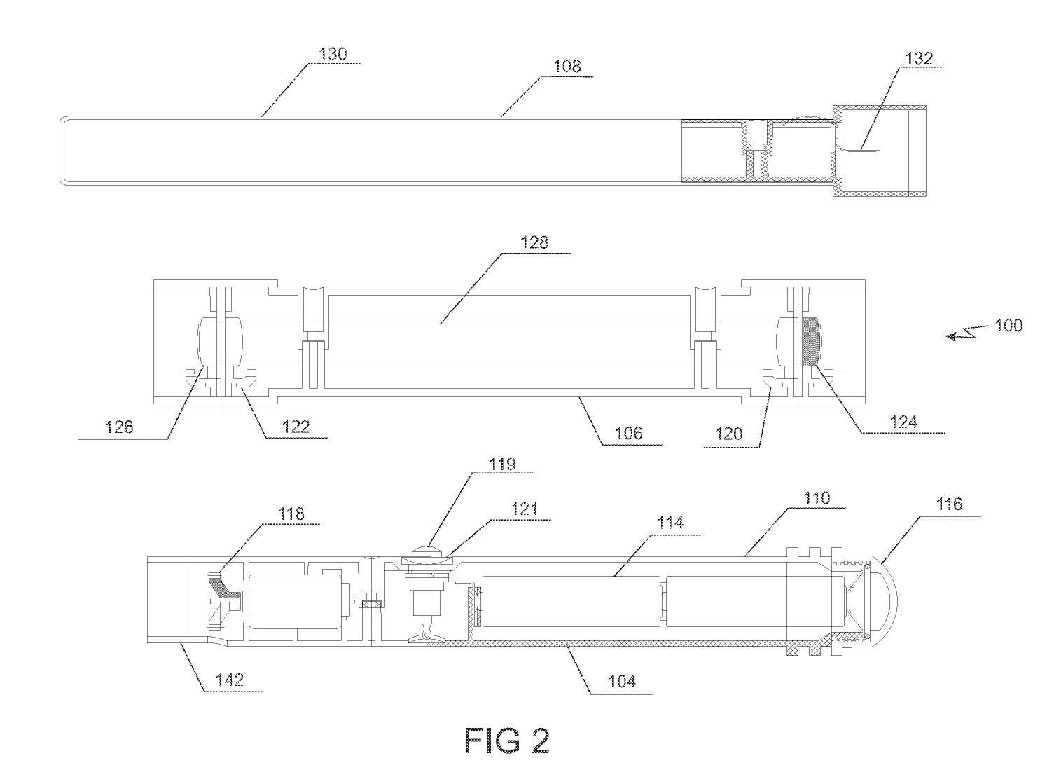

According to embodiments of the present invention, there is provided an electrostatic generating apparatus, depicted generally in FIG. 1 at 100. FIG. 1 depicts a front sectional view of the electrostatic generating apparatus 100 in an assembled state. Reference shall also be made to FIG. 2, which depicts a front sectional view of the electrostatic generating apparatus 100 in an un-assembled state.

Generally speaking, the electrostatic generating apparatus 100 is configured to produce an electrostatic charge. In the illustrated embodiment, the electrostatic generating apparatus 100 comprises a body 102, which in turn is made up of three components—a first body portion 104, a second body portion 106 and a third body portion 108. However, in alternative embodiments, the body 102 can be implemented as a singular or a two-component structure. It is noted that in this illustrated embodiment, the electrostatic generating apparatus 100 is implemented as a portable apparatus, but this does not need to be so in every embodiment of the present invention as will be described in greater detail herein below.

The second body portion 106 has two ends. In the illustrated embodiment, each of the two ends can be selectively coupled to one of the first body portion 104 and the third body portion 108, as will be discussed in greater detail herein below.

The first body portion 104 comprises a housing 110. The housing 110 contains a motive member 112 and a source of power 114 for powering the motive member 112. In the illustrated embodiment, the motive member 112 is implemented as an electric motor and the source of power 114 is implemented as at least one battery and, more specifically, a set of two AA batteries. The type of the electric motor used is not limited and, as such, the motor can be implemented as an AC motor, a DC motor, brushless motor, servo motor or the like.

Similarly, in alternative embodiments, the source of power 114 can comprise a different type of batteries or may be implemented as a cord that can be plugged into a power outlet, for example. In the illustrated embodiment, there is also provided a cover 116, which can be releasably attached to the housing 110 for selectively opening the interior of the housing 110 (to insert or replace the source of power 114, for example) and closing the interior of the housing 110 (to maintain the source of power 114 in an operational configuration).

Provided in accordance with embodiments of the present invention and operatively coupled to the motive member 112 is a driving gear 118 for rotation under the motive of the motive member 112. Even though in the specific embodiment, the driving gear 118 is depicted as a single gear, in alternative non-limiting embodiments, the driving gear 118 can be implemented as a series of gears.

Also provided, within the housing 110 are a switch button 119 housed within a gasket 121. Generally speaking, the function of the switch button 119 is to switch the electrostatic generating apparatus 100 on (when the switch button 119 is depressed) or off (when the switch button 119 is released). In the illustrated embodiment, the gasket 121 can be implemented as an electrically conductive member, function of which will be explained in greater detail herein below.

The second body portion 106 comprises a first driven gear 120 and a second driven gear 122, symmetrically located on either end of the second body portion 106. The first driven gear 120 and the second driven gear 122 can alternatively operatively engage with the driving gear 118 for the purpose of being driven by the driving gear 118, depending on which end of the second body portion 106 is coupled to the first body portion 104 in the operational configuration, as will be described in greater detail herein below.

The first driven gear 120 is operatively coupled to a first roller 124 (for example, by means of the first roller 124 being mounted on an axel coupled to the first driven gear 120 or by any other suitable means) and the second driven gear 122 is operatively coupled to the second roller 126 (for example, by means of the second roller 126 being mounted on an axel coupled to the second driven gear 122 or by any other suitable means) for respective rotation therewith.

Provided between the first roller 124 and the second roller 126 is a belt 128. When in use (i.e. when the switch button 119 is depressed), with the motive member 112 providing motive power, the driving gear 118 is rotated. That, in turn, and in the illustrated embodiment of the assembled state of FIG. 1, imparts rotation onto the first driven gear 120 (by means of operative connection between gear teeth thereof), which in turn imparts rotation onto the first roller 124, which in turns drives the belt 128. It is noted that in an alternative (i.e. reversed) operational configuration of the electrostatic generating apparatus 100, the driving gear 118 would engage and impart rotation onto the second driven gear 122.

Therefore, within embodiments of the present invention, the first roller 124, the second roller 126 and the belt 128 can be considered to be an “electrostatic charge separating member”, which is configured to separate/generate the electrostatic charge and pass it further onto a charge collector (to be described below).

The third body portion 108 includes a charge-collector 130 for accumulating the generated electrostatic charge. It is noted that the shape of the charge-collector 130 is not particularly limited. In the illustrated embodiment, the charge-collector 130 is implemented as an elongated cylindrical body. In alternative non-limiting embodiments of the present invention, the charge-collector 130 can be implemented in any different shape or form factor. Examples of such alternative implementations of the charge-collector 130 include but are not limited to a dome-shaped implementation and the like. Alternatively, the charge-collector 130 can be implemented in any desired shape.

It is also noted that the charge-collector 130 can be produced from any suitable electrically-conductive materials. In the illustrated embodiment, the charge-collector 130 is made of metal. In yet further non-limiting embodiments of the present invention, the charge-collector 130 can be implemented as a conductor with a high electrical resistance. In yet further non-limiting embodiments of the present invention, the charge-collector 130 can be implemented as insulator that breaks and becomes conductive under the voltage that is generated within the electrostatic generating apparatus 100.

Other materials that can be used for producing the charge-collector 130 include but by no means are limited to paper, cardboard, fabric, silicon, nylon, rubber, foam, styrofoam, certain types of plastic.

The charge-collector 130 comprises a collector member 132 that includes an electrode system, which in use (i.e. when the first body portion 104, the second body portion 106 and the third body portion 108 are assembled into an operational configuration) extends from the charge-collector 130 towards and terminates proximate to the belt 128. Generally speaking, the purpose for the collector member 132 is to collect the separated charge of a single polarity being carried to the collector member by the belt 128, as will be described in greater detail herein below.

In those embodiments of the present invention where the body 102 is implemented as a singular member, people skilled in the art will appreciate how to arrange the above-described elements. One of the technical effects of the embodiments of the present invention attributable at least in part to the use of the driving gear 118 is the fact that the motive member 112 can be arranged “in-line” with the rest of the components and specifically “in-line” with the electrostatic charge separating member. This in turn, may allow to make the electrostatic generating apparatus 100 more compact compared to the prior art implementations. This, in turn, may result in less real estate required to implement such a configuration, compared to the real estate required for the prior art implementations.

Within embodiments of the present invention, an axel (not separately numbered in FIG. 1) that is used for mounting the driving gear 118 onto the motive member 112 can be used as an electrode for collecting of a residual charge from the respective end of the belt 128 onto the motive member 112. In other words, the axel used for mounting the driving gear 118 can be used as a collector electrode Graaf (not separately numbered), made of metal or the like materials, which terminates in close proximity with the belt 128 and collects the residual charge on the motive member 112 from the belt 128. The use of the driving gear 118 is in sharp contrast to the use of the brush/comb of the prior art implementations of the Van de Graaf generators that relied on a separate brush/comb for collection of the residual charge.

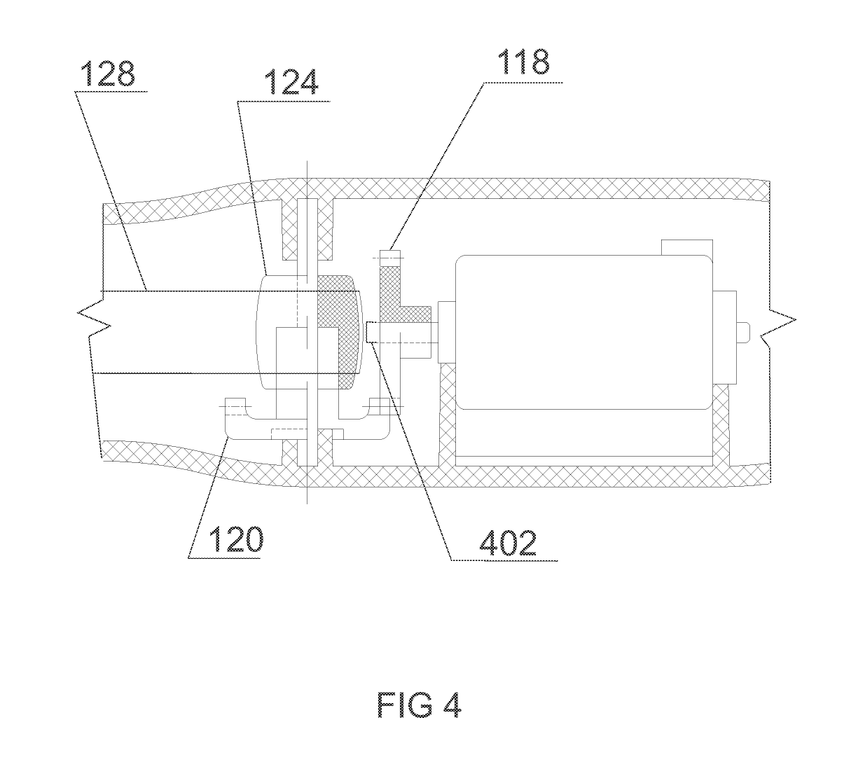

Another technical effect attributable at least partially to the use of the axel and a collector electrode can include alleviating the need for a separate collector brush. With brief reference to FIG. 4, which depicts a portion of the electrostatic generating apparatus 100 of FIG. 1, there is depicted an axel 402 used for mounting the driving gear 118 onto the motive member 112. It is shown that the axel 402 extends towards and terminates in close proximity to the belt 128 for collecting the residual charge therefrom.

In some embodiments of the present invention, the electrostatic generating apparatus 100 can be configured to generate an electrostatic charge having a selective polarity. This is particularly applicable but not limited to those embodiments where the body 102 comprises the aforementioned first body portion 104, second body portion 106 and third body portion 108. In other words and as will be described in greater detail below, the electrostatic generating apparatus 100 can be selectively configured to generate a negative charge or a positive charge.

Within these embodiments of the present invention, the first roller 124 is made of a first material and the second roller 126 is made of a second material. Within embodiments of the present invention, the first material and the second material are selected such that they are located on the opposite sides of triboelectric series (also referred to sometimes by those of skill in the art as “electronegativity scale”). It is noted that when referred to the “ends” of the triboelectric series inventors do not mean “extreme ends”, rather inventors mean that one material is selected towards one end (i.e. the upper part of the triboelectric series) and the other material is selected towards the other end (i.e. the lower part of the triboelectric series).

As is known to those of skill in the art, the triboelectric series is a list that ranks various materials according to their tendency to gain or lose electrons. It usually lists materials in order of decreasing tendency to charge positively (lose electrons), and increasing tendency to charge negatively (gain electrons). Somewhere in the middle of the list are materials that do not show strong tendency to behave either way.

The belt 128 is made of a third material, the third material being selected to be substantially in-between the first material and the second material vis-à-vis the triboelectric series.

In one of the non-limiting embodiments of the present invention, the first roller 124 can be made of Teflon, which is located close to the bottom of the triboelectric series. The second roller 126 can be made of either metal or Nylon, as an illustrative example, which are located in the upper region of the triboelectric series. Finally, in this illustrative embodiment, the belt 128 can be made of rubber, rubber being located in-between Teflon and metal or Nylon, vis-à-vis the triboelectric series.

The first body portion 104, the second body portion 106 and the third body portion 108 can be releasably joined together by any suitable means, such as by means of a threaded coupling, for instance. In the illustrated embodiment, the first body portion 104, the second body portion 106 and the third body portion 108 are releasably joined together by means of a twist and lock connection. To that extent, there are provided (i) a first lock joint 140 between the first body portion 104 and the second body portion 106 and (ii) a second lock joint 142 (see FIG. 2) between the second body portion 106 and the third body portion 108. It is noted that the actual implementation of the first lock joint 140 and the second lock joint 142 is substantially the same therebetween vis-à-vis location relative to the respective ends of the second body portion 106. This is what allows for either end of the second body portion 106 to be selectively operatively coupled to one of the first body portion 104 and the third body portion 108.

In embodiments of the present invention, the electrostatic generating apparatus 100 also comprises a charge transmitting member (not separately numbered) made at least partially of electrically conductive material and located at least partially on an outer surface of the body 102. The charge transmitting member is electrically coupled to the motive member 112. Generally speaking, the function of the charge transmitting member is to be a part of the electrode system providing ground for the electrostatic Van de Graaf generator, when the user becomes in contact with the charge transmitting member, during the operation of the electrostatic generating apparatus 100; the user serves as a ground for the electrostatic generating apparatus 100.

In the specific embodiment being depicted herein, the charge transmitting member is implemented as the gasket 121 and, thereby, the motive member 112 can be grounded by providing an electrical coupling (such as a wire, for example, or the like) between the motive member 112 and the gasket 121. In use, when a user (not depicted) turns the electrostatic generating apparatus 100 on by depressing the switch button 119, she touches and becomes in contact with the gasket 121. The grounding than occurs through the body of the user (not depicted). In alternative embodiments, the grounding can be implemented differently, for example, by means of a ground wire connectable into a ground socket of a power outlet, for example.

Alternatively, grounding can be provided by providing a wire from the motive member 112 that can be selectively coupled to a large metal object that can be placed on the floor of a lab where the electrostatic generating apparatus 100 is used, for example. The last illustrative example is particularly suitable but not limited to those embodiments where the electrostatic generating apparatus 100 implemented in a non-portable fashion. For example, this is specifically applicable in those embodiments where the electrostatic generating apparatus 100 is implemented as a stationary device.

In other embodiments of the present invention, it is contemplated that the grounding can be implemented by means of the motive member 112 collecting the charge onto its conductive housing (not separately numbered) and implementing a sporadic discharge from time to time. In yet alternative non-limiting embodiments, instead of relying on the motive member 112 for grounding, a separate structure known as “bottom collector” can be used.

Having described the non-limiting embodiments of the structure of the electrostatic generating apparatus 100, operation thereof will be described in greater detail specifically within the content of the embodiment where selective polarity is implemented. Generally speaking, depending which one of the first roller 124 and the second roller 126 is coupled at a location proximate to the collector member 132, a different polarity of the charge will be collected within the charge-collector 130. Recalling that the first roller 124 is made of the first material and the second roller 126 is made of a second material, one will appreciate that if the second roller 126 being made of the second material selected from the bottom of the triboelectric series is operatively coupled to the charge-collector 130 (and, accordingly, the first roller 124 is operatively coupled to the motive member 112), then the charge collected on the charge-collector 130 will be negative.

By the same token, if the first roller 124 being made of the first material selected from the top of the triboelectric series is operatively coupled to the charge-collector 130 (and, accordingly, the second roller 126 is operatively coupled to the motive member 112), then the charge collected on the charge-collector 130 will be positive. The process of generating and collecting of the charge in and of itself is well known to those of skill in the art and, as such, will not be described here at length.

The electrostatic generating apparatus 100 implemented in accordance with embodiments of the present invention can be used for various purposes, such as without limitation academic purposes, teaching static electricity, for various scientific experiments that call for tests with alternate charges. For example, some of the potential experiments may include but are not limited to using the electrostatic generating apparatus 100 of FIG. 1 to demonstrate a test how the positively charged and the negatively charged charge-collector 130 affects a stream of tap water, for example. Other examples will become apparent to those of skill in the art.

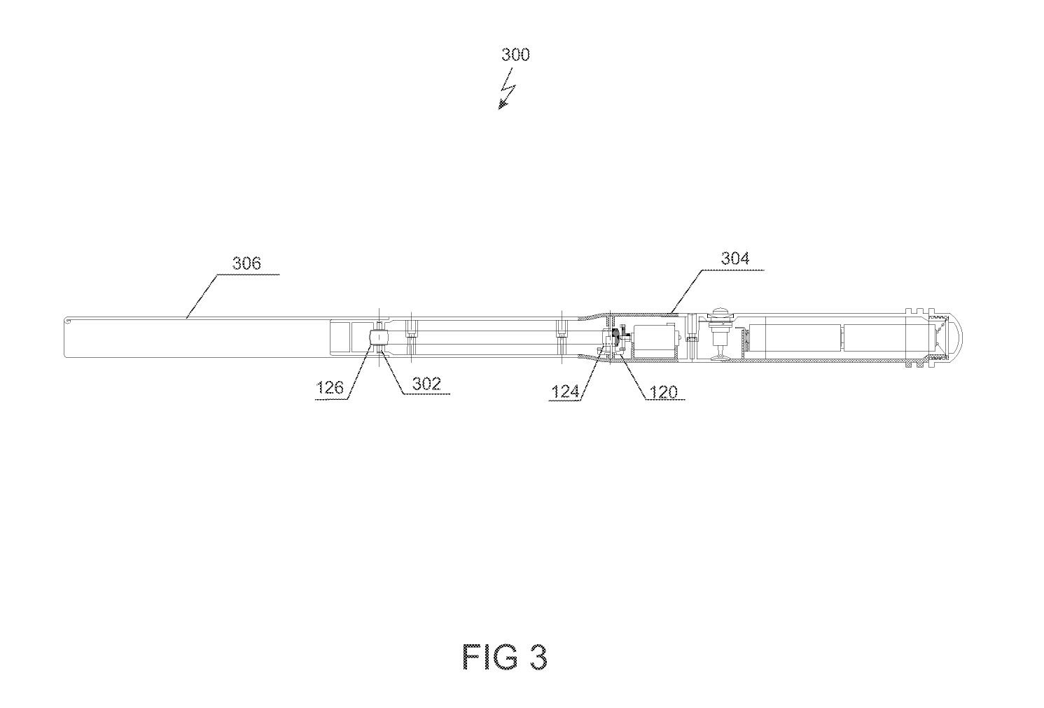

Even though in the above-illustrated embodiments, both the first roller 124 and the second roller 126 are mounted onto a respective driven gear, this does not need to be so in every embodiment of the present invention. For example, in alternative embodiments of the present invention, only one of the first roller 124 and the second roller 126 can be mounted on the respective driven gear. This non-limiting embodiment illustrated with reference to FIG. 3, which depicts a front sectional view of the electrostatic generating apparatus in an assembled state, the electrostatic generating apparatus being implemented in accordance with another non-limiting embodiment of the present invention. FIG. 3 depicts an electrostatic generating apparatus 300, which is substantially similar to the electrostatic generating apparatus 100 described above other then for the specific differences discussed immediately below. Within these embodiments of the present invention, only one of the first roller 124 and the second roller 126 (namely the first roller 124) is mounted onto the respective driven gear (namely the first driven gear 120), while the second roller 126 is mounted onto an axel 302. It is also worthwhile noting the body 102 of the electrostatic generating apparatus 300 is made of two parts—(i) a first part 304 housing the motive member, the source of power, and a charge separating member and (ii) a second part 306 housing the charge-collector 130.

The description of the embodiments of the present inventions provides examples of the present invention, and these examples do not limit the scope of the present invention. It is to be expressly understood that the scope of the present invention is limited by the claims only. The concepts described above may be adapted for specific conditions and/or functions, and may be further extended to a variety of other applications that are within the scope of the present invention. Having thus described the embodiments of the present invention, it will be apparent that modifications and enhancements are possible without departing from the concepts as described. Therefore, what is to be protected by way of letters patent are limited only by the scope of the following claims:

1. An electrostatic generating apparatus comprising:
a body housing:
an electrostatic charge separating member for generating an electrostatic charge;
a motive member and a source of power for providing motive to the electrostatic charge separating member;
a charge-collector for collecting the electrostatic charge;
the electrostatic charge separating member including a first roller, a second roller and a belt therebetween;
the motive member including a driving gear mounted onto the motive member, the driving gear configured to operatively engage at least one of the first roller and the second roller for imparting the movement onto the belt.

2. The electrostatic generating apparatus of claim 1, wherein the driving gear is mounted onto an axel of the motive member and wherein the driving gear and the axel are configured such that the axel terminates in close proximity to the belt for collecting of a residual charge therefrom.

3. The electrostatic generating apparatus of claim 1, wherein at least one of the first roller and the second roller is mounted onto a respective driven gear and wherein, in use, the respective driven gear operatively engages the driving gear.

4. The electrostatic generating apparatus of claim 3, wherein both the first roller and the second roller are mounted onto a respective driven gear.

5. The electrostatic generating apparatus of claim 2, wherein the body further comprises a charge transmitting member made at least partially of electrically conductive material and located at least partially on an outer surface of the body, and wherein said charge transmitting member is eclectically coupled to the motive member.

6. The electrostatic generating apparatus of claim 5, wherein a user becomes in contact with the charge transmitting member during the operation of the electrostatic generating apparatus, whereby the user serves as a ground for the electrostatic generating apparatus.

7. The electrostatic generating apparatus of claim 6, wherein the charge transmitting member is implemented as a gasket of a switch button.

8. The electrostatic generating apparatus of claim 1, wherein
the body includes a first body portion, a second body portion and a third body portion; each end of the second body portion being configured to selectively alternatively operatively couple to one of the first body portion and the third body portion, in an operational configuration;
the first body portion housing the motive member and the source of power;
the second body portion housing the electrostatic charge separating member;
the third body portion housing the charge-collector;
the electrostatic charge separating member being configured to generate the electrostatic charge having a selective one of a positive polarity and a negative polarity depending which end of the second body portion is coupled to the third body portion.

9. The electrostatic generating apparatus of claim 8, wherein the first roller is provided at one end of the second body portion and the second roller is provided at another end of the second body portion, symmetrically therebetween relative to the one end and the other end of the second body portion.

10. The electrostatic generating apparatus of claim 8, wherein the first roller is made of a first material, the second roller is made of a second material and the belt is made of a third material; wherein the first material is selected from the upper part of triboelectric series, the second material is selected from the bottom part of the triboelectric series and the third material is selected substantially in-between the first material and the second material vis-à-vis the triboelectric series.

11. The electrostatic generating apparatus of claim 8, wherein the third body portion is made of one of:
an electrically-conductive material;
a conductor with high electrical resistance;
an insulator that breaks and becomes conductive under the voltage generated by the electrostatic generating apparatus.

12. The electrostatic generating apparatus of claim 8, wherein the first roller is mounted onto a first driven gear and the second roller is mounted onto a second driven gear.

13. The electrostatic generating apparatus of claim 12, wherein the first roller is provided at one end of the second body portion and the second roller is provided at another end of the second body portion, symmetrically therebetween relative to the one end and the other end of the second body portion; and wherein in a first operational configuration the first driven gear engages the driving gear and in a second operational configuration the second driven gear engages the driving gear.

14. The electrostatic generating apparatus of claim 1, wherein the charge-collector comprises a collector member extending from the charge-collector towards and terminates proximate to the belt for collecting the electrostatic charge; and wherein the collector member is made from electro-conductive material.

15. An electrostatic generating apparatus comprising:
a body including a first body portion, a second body portion and a third body portion;
the second body portion being configured to selectively alternatively operatively couple to one of the first body portion and the third body portion, into a first operational configuration and a second operational configuration, respectively;
the electrostatic generating apparatus being configured to generate a charge of a positive polarity in said first operational configuration and a charge of a negative polarity in said second operational configuration.

16. The electrostatic generating apparatus of claim 15, wherein each end of the second body portion is selectively connectable to one of the first body portion and the third body portion and wherein said first operational configuration and said second operational configuration depends of which one of the ends of the second body portion is coupled to the third body portion that includes a charge-collector for accumulating the charge.

17. In an electrostatic generating apparatus having an electrostatic charge separating member and a motive member, the improvement comprising that the motive member is used for grounding.

18. The electrostatic generating apparatus of claim 17, wherein the motive member comprises a portion that terminates in a close proximity to a portion of the electrostatic charge separating member for collecting of a residual charge therefrom.
